(19) United States
(12) Patent Application Publication
(10) Pub. No.: US 2026/0178002 A1
(43) Pub. Date: Jun. 25, 2026

(54) COLLABORATIVE AGENTS FOR MANAGING ENERGY CONSUMING DEVICES AND METHODS THEREON

(71) Applicant: LOD Technologies Inc., Burnaby (CA)

(72) Inventors: Medi Naserimojarad, Vancouver (CA); Mostafa Shariat, Vancouver (CA)

(21) Appl. No.: 19/540,215

(22) Filed: Feb. 13, 2026

Related U.S. Application Data
(63) Continuation-in-part of application No. 18/989,975, filed on Dec. 20, 2024, now Pat. No. 12,560,901.
(60) Provisional application No. 63/700,721, filed on Sep. 29, 2024.

(51) Int. Cl. G05B 15/02; H04L 67/125

(52) U.S. Cl. CPC G05B 15/02; H04L 67/125

(57) ABSTRACT

A system and method for monitoring and managing devices is provided. The system includes a network including a cooling system, control agents connected to the devices, each control agent assigned to a batch of devices to share management. Each control agent is configured to monitor at least one device by obtaining data representing a status and at least one metric associated with operation of the device including temperature associated with cooling devices or a zone served by the cooling system, generate a command for satisfying a temperature target for the cooling system, send the command to the device, and monitor execution of the command by the at least one device. The command is re-sent when not executed or there is an unexpected change in the status of the device after successful execution. Where the command is re-sent and after an elapsed time, the control agent proactively takes corrective action.

### TECHNICAL FIELD

The present disclosure generally relates to managing Internet of Things (“IoT”) devices, and more particularly relates to managing IoT devices using collaborative control agents.

### BACKGROUND OF THE INVENTION

In modern datacenters, managing a large number of devices, such as application-specific control circuits (ASICs) and power distribution units (PDUs), presents challenges in terms of scalability, reliability, and efficiency. Traditional systems rely heavily on centralized control, which can create bottlenecks, latency issues, and single points of failure. As IoT deployments in datacenters grow, the limitations of current centralized management systems become apparent. Central servers can become overwhelmed, resulting in delayed responses or failed command execution. Moreover, there is a lack of adaptability in handling offline agents or the introduction of new agents. Systems are generally ill-equipped to optimize energy consumption or manage devices efficiently across multiple infrastructure layers, which further complicates operations and increases costs. These issues highlight the need for a more distributed, resilient, and intelligent approach to managing IoT devices, as existing solutions often fail to provide sufficient redundancy, dynamic load balancing, and efficient communication between devices, leading to unoptimized resource use and potential system downtime.

Accordingly, due to the increasing complexity of Internet of Things (IoT) systems and greater energy efficiency needs, there is a need for better systems for monitoring, control, and communication in respect of IoT devices.

### SUMMARY

Provided herein is a system for monitoring and managing a plurality of devices including at least one energy-consuming device in a facility. The system includes a network including the plurality of devices, the plurality of devices including a cooling system including one or more cooling devices, a plurality of control agents connected to the plurality of devices, each control agent from the plurality of control agents being assigned to a batch of devices from the plurality of devices to share management of the plurality of devices among the plurality of control agents. Each respective control agent from the plurality of control agents is configured to monitor at least one device in the assigned batch of devices by obtaining data representing a status of the device and at least one metric associated with operation of the device, the at least one metric including a temperature metric associated with one or more of the cooling devices or a zone of the facility served by the cooling system, generate a command based at least in part on the data, the command being configured to satisfy a temperature target for the cooling system, send the command to the at least one device in a closed-loop manner. The respective control agent further monitors execution of the command by the at least one device. The command is re-sent where the command is not executed by the at least one device or where there is an unexpected change in the status of the at least one device after successful execution of the command. Where the command is re-sent and after an elapsed time, the respective control agent proactively takes corrective action to verify that the temperature target for the cooling system is satisfied.

The one or more cooling devices may include at least one of a fan, pump, refrigeration unit, air-conditioning unit, and chiller.

The command may include at least one of: changing a fan speed, changing a pump speed, enabling or disabling a refrigeration cycle, and switching on or off the one or more cooling devices.

The at least one metric may further include at least one additional metric selected from power-consumption metrics, environmental-impact-related metrics, and device-health metrics, and the respective control agent may be configured to generate the command based at least in part on the one additional metric.

The command may be further generated based on one or more control targets for operation of the facility, and the one or more control targets may include at least a first control target based on one or more of an energy-consumption targets, energy-cost objective, an energy-sourcing mix target, and environmental impact targets for the facility and a second control target based on ensuring the temperature target for the cooling system. The respective control agent may be configured to generate the command based at least in part on both the first control target and the second control target.

The one or more control targets may be obtained based on one or more energy agreements or program obligations applicable to the facility.

A target power-consumption profile for the facility over a plurality of time intervals may be obtained based at least in part on the one or more energy agreements.

The plurality of devices may further include one or more power-routing devices configured to route electrical energy from at least two power sources selected from an energy grid, a behind-the-meter generation resource, and an energy storage unit, and the one or more control targets may further include an energy-sourcing mix target specifying proportions or ranges of power to be obtained from the at least two power sources, and the command may be configured to cause the one or more power-routing devices to implement the energy-sourcing mix target.

The energy-sourcing mix target may specify a minimum or maximum percentage of power to be supplied from the energy grid, the behind-the-meter generation resource, or the one or more energy storage units over one or more time intervals.

The plurality of devices may include one or more energy storage units, and the one or more control targets may further include at least one state-of-charge (SOC)-related target for the one or more energy storage units, and at least one control agent may be configured to generate the command based at least in part on a measured SOC of the one or more energy storage units so as to maintain the measured SOC within a corresponding SOC-related target.

A computer-implemented method for monitoring and managing a plurality of devices including at least one energy-consuming device in a facility is provided. The method includes providing a network including the plurality of devices, the plurality of devices including a cooling system including one or more cooling devices, assigning, by one or more processors, a plurality of control agents to respective batches of devices from the plurality of devices to share management of the plurality of devices among the plurality of control agents, for each respective control agent from the plurality of control agents monitoring at least one device in the assigned batch of devices by obtaining data representing a status of the device and at least one metric associated with operation of the device, the at least one metric including a temperature metric associated with one or more of the cooling devices or a zone of the facility served by the cooling system, generating, based at least in part on the data, a command configured to ensure a temperature target for the cooling system, sending the command to the at least one device in a closed-loop manner, monitoring execution of the command by the at least one device, and when the command is not executed by the at least one device or when there is an unexpected change in the status of the at least one device after successful execution of the command, re-sending the command and, when the command is re-sent and an elapsed time passes, proactively taking corrective action to verify the temperature target is ensured.

The one or more cooling devices may include at least one of a fan, pump, refrigeration unit, air-conditioning unit, or chiller.

Generating the command may include at least one of: changing a fan speed, changing a pump speed, enabling or disabling a refrigeration cycle, and switching on or off the one or more cooling devices.

The at least one metric may further include at least one additional metric selected from power-consumption metrics, environmental-impact-related metrics, and device-health metrics, and generating the command may include generating the command based at least in part on the at least one additional metric.

The method may further include determining one or more control targets for operation of the facility, the one or more control targets including at least a first control target based on one or more of an energy-consumption target, an energy-cost objective, an energy-sourcing mix target, and an environmental impact target for the facility, and a second control target based on ensuring the temperature target for the cooling system. Generating the command may include generating the command based at least in part on both the first control target and the second control target.

The method may further include obtaining one or more energy agreements or compliance agreements applicable to the facility, and determining the one or more control targets may include determining the one or more control targets based at least in part on the one or more energy agreements, and at least one of the control targets may include a target power-consumption profile for the facility over a plurality of time intervals obtained based at least in part on the one or more energy agreements.

The plurality of devices may further include one or more power-routing devices configured to route electrical energy from at least two power sources selected from an energy grid, a behind-the-meter generation resource, and an energy storage unit, and the one or more control targets may further include an energy-sourcing mix target specifying proportions or ranges of power to be obtained from the at least two power sources, and generating the command may include generating the command to cause the one or more power-routing devices to implement the energy-sourcing mix target.

The plurality of devices may include one or more energy storage units, and the one or more control targets may further include at least one state-of-charge (SOC)-related target for the one or more energy storage units, and generating the command may include generating the command based at least in part on a measured SOC of the one or more energy storage units so as to maintain the measured SOC within a corresponding SOC-related target.

Provided herein are systems and methods for managing IoT devices. A system for monitoring and managing a plurality of devices including one or more energy-consuming devices in a facility is provided. The system includes a network including the plurality of devices, a plurality of control agents connected to the plurality of devices, and a cloud server connected to the plurality of control agents. Each control agent from the plurality of control agents is dynamically assigned to a batch of devices from the plurality of devices according to an assignment criterion to share management of the plurality of devices among the plurality of control agents, and each control agent monitors (reading and tracking) status, data, and metrics of each device in the assigned batch of devices and/or sends a command to the device in a closed loop manner. Execution of the command is monitored by the control agent and the command is re-sent in case the command is not executed by the device or in case there is no status change in the device after successful execution of the command.

The cloud server may include one or more servers for improved backup, reliability, and redundancy. The control agent may monitor the execution of the command continuously with a set frequency. If the command is not executed as expected or if the device has unexpectedly changed its status after successful execution of the commands and after an elapsed time, such that it renders the command as not executed, the control agent may resend the command or may take corrective action.

The assignment criteria may be based on one or more of: a random assignment protocol, a location of each device in the plurality of devices an address range of the device, and an electrical phase powering the device. The assignment criteria may be defined by the cloud server or a select control agent from the plurality of control agents. The select control agent may be a superior agent or an agent with a certain criterion.

Each control agent from the plurality of agents may assume a role where a control agent with an assumed role is a master in the role among the plurality of control agents. The role may be selected from one or more of: a master network agent, and a master device command agent.

The plurality of devices may be assigned to the control agents according to an IP address, a physical address of the control agents, and/or based on capacity of the control agents.

A first and a second control agent may be assigned to the same batch of devices in the network. The first and the second control agents may monitor and send commands to the devices of the assigned batch of devices simultaneously.

If a new control agent is added to or goes offline from the network, or if new devices are added to or removed from the network, assignment of available devices from the plurality of devices may be redistributed among available control agents from the plurality of control agents. If a workload on one or more control agents from the plurality of control agents is imbalanced, the plurality of control agents may rebalance the assigned batch of devices to improve load balancing among the plurality of control agents.

The redistribution of the assignment of the available devices to the available control agents may be carried out by a rebalancing command initiating from the cloud server or from a control agent from the plurality of control agents. The rebalancing command may be broadcasted by a control agent to all other control agents in the plurality of control agents.

When a new control agent is added to the network, the new control agent may identify its assigned local IP and MAC address to the cloud server or other control agents in the network to facilitate rebalancing of the plurality of devices to the plurality of control agents.

A first control agent may detect a second control agent going offline and the plurality of control agents may be reassigned to the plurality of devices to fill-in for the second control agent.

The system may further include a log file including a list of the plurality of control agents, their status, and their assigned batch of devices. The log file may be accessible to and modifiable by each control agent from the plurality of control agents.

A control agent from the plurality of control agents may be requested (either manually or automatically according to a rule) to scan for new or missing devices connected to the network.

A device from the plurality of devices may be a frequency meter configured to measure frequency of electrical energy supplied to the facility, and data monitored from the frequency meter may trigger a command generated at a control agent to modify the operation of one or more of the devices from the plurality of the devices.

A system for monitoring and managing a plurality of devices including one or more energy-consuming devices in a facility is provided. The system includes a network including the plurality of devices, a plurality of control agents connected to the plurality of devices, each control agent from the plurality of control agents being assigned to a batch of devices from the plurality of devices according to one or more assignment criteria to share management of the plurality of device among the plurality of control agents, and a cloud server connected to the plurality of control agents. Each control agent monitors each device by reading and tracking status, data, and metrics of the device in the assigned batch of devices and sending a command to the device in a closed-loop manner. Execution of the command is monitored by the control agent. The command is re-sent where the command is not executed by the device or where there is an unexpected change in the status of the device after successful execution of the command.

The cloud server may include one or more servers.

The control agents may monitor the execution of the command continuously with a set frequency.

Where the command is not executed by the device or where there is an unexpected change in the status of the device after successful execution of the command, and after an elapsed time, the control agent may take corrective action.

The assignment criteria may include one or more of: a randomly assigned protocol, a physical address of each control agent, a capacity of the control agent, a location of each device in the plurality of devices, an address range of the device, and an electrical phase powering the device.

The one or more assignment criteria may be defined by the cloud server or a selected control agent from the plurality of control agents.

The selected control agent may be a superior agent or an agent with a certain criterion.

Each control agent from the plurality of agents may be configured to assume a role in response to the command, and a control agent with an assumed role may be a master in the role among the plurality of control agents.

The role may include a master network agent and a master device command agent.

Multiple control agents, from the plurality of control agents, may be assigned to the same batch of devices.

Each of the multiple control agents may be configured to monitor and send commands to the devices of the assigned batch of devices simultaneously.

Where a new control agent is added to or goes offline from the network, assignment of the plurality of devices may be redistributed among available control agents from the plurality of control agents.

Where workloads on one or more control agents from the plurality of control agents are imbalanced, the plurality of control agents may be configured to redistribute the assigned batch of devices to improve load balancing among the one or more control agents on which the workloads are imbalanced.

The redistribution of assignment of the available devices to the available control agents may be effected by a rebalancing command initiated from the cloud server or from a control agent from the plurality of control agents.

The rebalancing command may be broadcasted by a control agent to all other control agents in the plurality of control agents.

When a new control agent is added to the network, the new control agent may identify an assigned local IP and MAC address to the cloud server or other control agents in the network to facilitate rebalancing of the plurality of devices to the plurality of control agents.

A first control agent may be configured to detect a second control agent going offline, and the plurality of control agents may be configured to be reassigned to the plurality of devices to fill in for the second control agent.

The system may further include a log file stored at the cloud server and/or on a control agent, the log file including a list of the plurality of control agents, a status of each of the plurality of control agents, and the batch of devices assigned to each of the plurality of control agents.

The log file may be accessible to and modifiable by each control agent from the plurality of control agents.

A control agent from the plurality of control agents may be configured to be requested, manually or automatically according to a rule, to scan for new or missing devices connected to the network.

A device, from the plurality of devices, may be a frequency meter configured to measure frequency of electrical energy supplied to the facility, and data monitored from the frequency meter may be configured to trigger a command generated at a control agent, from the plurality of control agents, to modify the operation of one or more of the devices.

A method for monitoring and managing a plurality of devices including one or more energy-consuming devices in a facility is provided. The method includes assigning a plurality of control agents, from a plurality of control agents, to a batch of devices, from a plurality of devices, according to one or more assignment criteria to share management of the plurality of devices among the plurality of control agents, and connecting a cloud server to the plurality of control agents. Each control agent monitors each device by reading and tracking status, data, and metrics of the device in the assigned batch of devices and sending a command to the device in a closed-loop manner. Execution of the command is monitored by the control agent. The command is re-sent where the command is not executed by the device or where there is no change in the status of the device after successful execution of the command.

Other aspects and features will become apparent to those ordinarily skilled in the art upon review of the following description of specific disclosed embodiments in conjunction with the accompanying figures.

### BRIEF DESCRIPTION OF THE DRAWINGS

In the following, embodiments of the present disclosure will be described with reference to the appended drawings. However, various embodiments of the present disclosure are not limited to the arrangements shown in the drawings.

FIG. 1 is a schematic diagram showing the disclosed device management system, according to an embodiment;

FIG. 2A to 2C are a series of schematic diagrams showing various configurations of assigned devices to control agents of the device management system of FIG. 1, according to respective embodiments; and

FIG. 3 is a schematic diagram of a processor circuit for implementing a control agent of the device management system of FIG. 1, according to an embodiment;

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Throughout this disclosure, compliance obligations may refer to both contractual agreements, such as energy agreements defined and exemplified later in the description, and government or industry regulations, such as data privacy and environment, social, governance (ESG) regulations.

Network refers to the interconnected system of IoT devices, control agents, and one or more cloud servers. The network refers both to the interconnected system of local devices within a facility, as well as its connection with off-site and remote servers and devices. The Network includes the communication infrastructure that enables data exchange, monitoring, and command execution between these components. The network encompasses both the physical connections (such as wired or wireless links) and the protocols (like TCP/IP, Bluetooth™, or Zigbee™) used to facilitate communication and coordination between devices, agents, and the cloud.

Load shaping refers to deliberate management and adjustment of a facility's power consumption profile over time. For example, datacenters may use load shaping to reduce peak power demands, take advantage of low energy prices or avoid times of high prices, enhance energy efficiency, and potentially participate in demand response programs and ancillary services related to a power grid.

Sending or commissioning instructions or commands to a device may refer to sending instructions to the device itself or a controller overseeing one or more devices including the device. The instructions or commands may include high-level strategies (e.g., follow a power consumption target directive, prioritize environmental impacts over cost savings), may include detailed tasks (e.g., shut down a single device, shutdown all or a certain percentage of connected devices, adjusting power consumption of one or more connected device), or may be a combination thereof.

In this disclosure, among other solutions, a distributed approach for IoT device monitoring and control is introduced, where a cloud server coordinates control agents that directly manage IoT devices. These agents handle device monitoring, data collection, and command execution in a closed-loop manner, ensuring continuous oversight. The control agents autonomously reissue commands if execution fails, stop devices if necessary, and even share control responsibilities among themselves, providing redundancy. This decentralized approach reduces reliance on a central server, minimizes single points of failure, and improves responsiveness by allowing agents to manage devices independently or in cooperation.

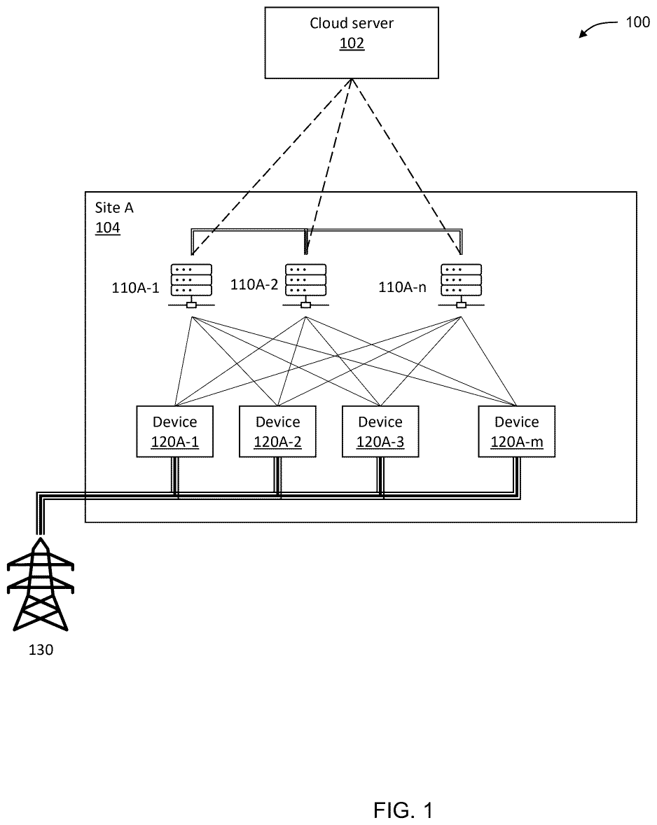

Referring now to FIG. 1, a schematic diagram of an Internet of things (IoT) device management system is generally shown at 100, according to an embodiment. The system 100 includes a cloud server 102 connected to a network of local control agents 110A-1 to 110A-n (collectively referred to as the agents 110 and generically as the agent 110) at a facility 104, such as site A. The agents are connected (wiredly or wirelessly) to one or more IoT devices 120A-1 to 120A-m (collectively referred to as the devices 120 or IoT devices 120 and generically as the device 120 or IoT device 120, to manage the operation of IoT devices (e.g. read data, send commands, send queries, track device status, etc.).

In an embodiment, Site A is a datacenter facility (e.g. data storage and processing centers and cryptocurrency mining sites) and the IoT devices are ASICs and PDUs in the datacenter facility.

In other embodiments, Site A is a facility selected from the group consisting of power generation facilities, Energy storage facilities, smart building facility, and a facility with a swarm of robots (e.g., a material mining site with autonomous ground and aerial vehicles).

The IoT devices 120 may include electrical motors, actuators, sensors, power storage units, robots, vehicles, and computers which are connected to the network. The devices 120 consume electrical energy, and their energy may be sourced from various sources such as power grid 130, an on-site or off-site power generation unit (not shown), or on-site or off-site energy storage units (such as back-up batteries) (not shown). The device management system 100 may further include other sites and facilities (e.g. Site B, Site C, etc.) (not shown). For example, the cloud server 102 may be in communication with control agents in other local or remote facilities, providing a broader network of connected devices. In an embodiment, a control agent in one facility (e.g., agent 110A-1 from Site A 104) is assigned to devices in other facilities (e.g. Site B) to monitor and control them.

In some embodiments, the facility 104 is electrically coupled to a plurality of power sources. The plurality of power sources may include one or more of: the energy grid 130 (or a utility power grid), one or more behind-the-meter (BTM) power generation units such as solar photovoltaic arrays, wind turbines, or fuel-based generators, and one or more energy storage units such as battery packs, battery racks, or other electrical energy storage systems. The devices 120, which may include power storage units, power distribution units, switches, inverters, and other power-routing infrastructure, and energy-consuming devices such as process equipment, lighting equipment, and cooling-related equipment (for example, fans, pumps, refrigeration systems, chillers, and air-handling units), may be configured to receive electrical energy from one or more of these power sources at a given time. In some implementations, power from the plurality of power sources is routed through one or more power transfer switches or other digitally-controlled power converters that are configured to enable or disable flow of power from the different sources and to mix energy from multiple sources before supplying it to the energy-consuming devices. In certain implementations, the collaborative, multi-agent control architecture described herein coordinates operation of the power-routing infrastructure and the energy-consuming devices so that facility-level control targets, such as target power-consumption profiles and/or target temperature profiles for one or more zones or equipment groups, are achieved over a plurality of time intervals.

In certain embodiments, the system 100 maintains an energy sourcing mix target for the facility 104. The energy sourcing mix target may specify, for one or more time intervals, desired proportions of instantaneous power or cumulative energy to be obtained from each power source. For example, for a given hour, the energy sourcing mix target may specify that at least a first percentage (e.g., 60%) of power is to be supplied from the energy grid 130, a second percentage (e.g., 20%) of power is to be supplied from a BTM power generation unit, and a third percentage (e.g., 20%) of power is to be supplied from an energy storage unit. In some cases, the energy sourcing mix target may be expressed as a range for each source (e.g., between 40% and 80% from the energy grid 130), or may specify minimum and/or maximum contribution thresholds for particular sources. In other scenarios, the energy sourcing mix target may correspond to an event-based mixing strategy that changes as a function of grid price, overall facility load, or grid frequency, such as sourcing up to a given percentage from the BTM supply and a given percentage from an energy storage system when grid energy prices exceed a threshold, when total energy consumption in the facility exceeds a threshold, or when grid frequency crosses a specified limit. In some embodiments, the energy sourcing mix target is determined in coordination with other control targets, such as target power-consumption profiles and target temperature profiles for one or more zones or equipment groups within the facility 104, so that sourcing decisions support both energy and cooling or temperature management objectives.

In some examples, the energy sourcing mix target is determined or updated by the cloud server 102 and/or by one or more other computing controllers, which may include on-premise controllers at the facility 104, based on one or more factors including, but not limited to: current or forecasted energy prices for the energy grid 130 or BTM generation; contractual obligations or incentives defined in energy agreements; carbon intensity or other environmental-impact metrics associated with each power source; and operational constraints of the energy storage units, such as maximum charge or discharge rates and thermal or cooling constraints associated with facility equipment. The energy sourcing mix target may be communicated to the agents 110 as a set of high-level directives or parameters that guide how the agents 110 select and control devices 120 to route power from different sources to loads within the facility 104. In some embodiments, the energy sourcing mix target and associated mixing strategy are determined using rule-based logic, programmatic heuristics, or machine-learning or reinforcement-learning models that operate on the input data described herein. In further embodiments, the energy sourcing mix target is computed as part of a joint optimization that also determines target power-consumption profiles and/or target temperature profiles over a set of time intervals, enabling the system 100 to co-optimize energy sourcing, energy use, and temperature or cooling performance.

The communication between the cloud server 102, the agents 110, and the devices 120 is facilitated by one or more wired or wireless communication protocols, including but not limited to TCP/IP, Bluetooth, WiFi, Lora™, Zigbee, and other wired or wireless options. This ensures robust communication channels suited to different operational requirements in various applications and for various types of facilities.

The cloud server 102 is configured to act as the supervisory entity of the entire system 100. The cloud server 102 oversees the overall network, manages agent allocation, sets up rules for device management, and may initiate rebalancing commands. The cloud server 102 is configured to assign or reassign the IoT devices 120 to one or more control agents 110 based on one or more criteria such as device location, IP address ranges, or electrical infrastructure phases of the devices 120. In cases where device rebalancing is desired, the cloud server 102 is further configured to broadcast rebalancing commands to the agents 110. The cloud server 102 may include one or more servers including a backup server to support workload and redundancy in case of failure of the main server.

Although the cloud server 102 coordinates high-level activities, the control agents 110A-1 to 110A-n are configured to operate independently and to autonomously control many responsibilities, ensuring the system 100 continues functioning if the cloud server 102 is unavailable or if network latency becomes problematic.

Each IoT device 120 includes a unique ID to be identifiable in the network. The ID assigned to each device 120 may be the assigned internet protocol (IP) address assigned to each device 120 when deployed to the network, may be the unique MAC or physical address of each device 120, or may be any other unique identifier associated with each device 120 in the network. In an embodiment, the ID of the devices 120 is collected by an agent 110 from the plurality of agents 110 and is broadcasted across the network, including to the other agents 110 and to the cloud server 102. The IP address of each device 120 may be assigned in various ways such as DHCP (i.e., each device 120 receives an arbitrary IP address related to a network they are connected to), static IP address proposed by the device 120 (i.e. the device 120 requests a certain IP address from a network administrator and is assigned with the default proposed IP address if the address is available), and static IP proposed by a router/switch (which may be a control agent 110) where the device 120 is connected to a connection port (e.g., ethernet port) of the router and the device 120 is assigned the IP address which is assigned to the connection port.

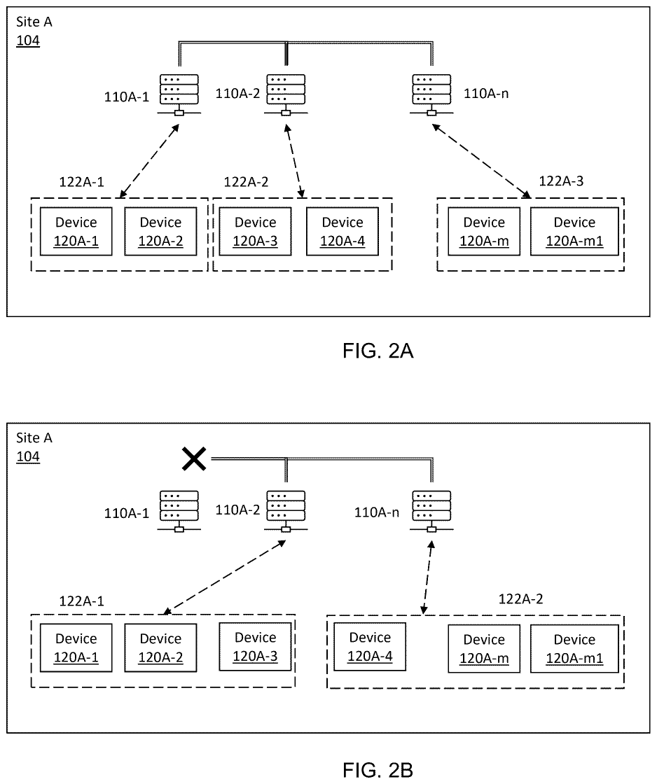

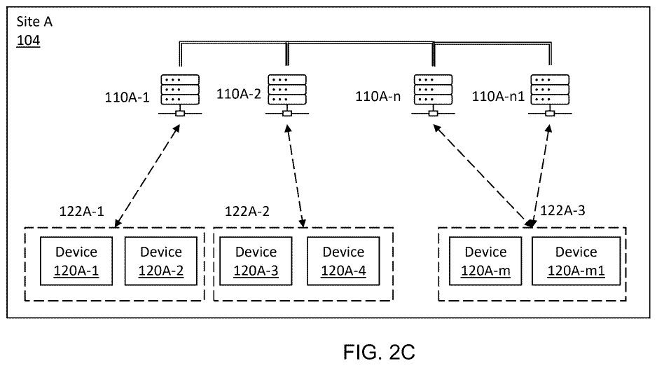

The control agents 110 are configured to facilitate managing the devices 120. Each agent 110 is assigned to manage a batch of devices 120 (e.g. device batch 122A-1 assigned to agent 110A-1 as shown in FIG. 2A) to enable distribution of device management tasks among multiple agents 110 rather than just one cloud server 102. Each agent (e.g., agent 110A-1) is not only responsible for continuously monitoring the batch of devices (e.g. device batch 122A-1) but is further responsible for sending or commissioning commands (e.g. turn off, restart, overclock, underclock, change status, etc.) to the assigned device batch (e.g., device batch 122A-1). For effective execution of commands sent to the devices 120, each agent 110 commissions commands to the devices 120 in a closed-loop fashion. In the closed-loop fashion, the agent 110 monitors and tracks the execution status of the commands by the devices 120 and, if the devices 120 fail to execute commands correctly, the agent 110 autonomously resends the commands or takes corrective action. Commissioning the commands and tracking the execution status of the commands on the devices 120 may be implemented by the agents 110 continuously or periodically with a set frequency (e.g. every 5 minutes, at 1 pm every day). The control agents 110 may be configured to query the IoT devices 120, read/write data to and from the devices 120 (e.g. response by the device 120 to a query by the agent 110, device data published by the device 120, modifying configuration of the devices 120 such as modifying state of the devices 120), applying logic rules, and outputting calculation and rule evaluation results. The agents 110 may be configured to pull data from the device 120 status of the device 120, performance metrics of the device 120, and health data of the device 120.

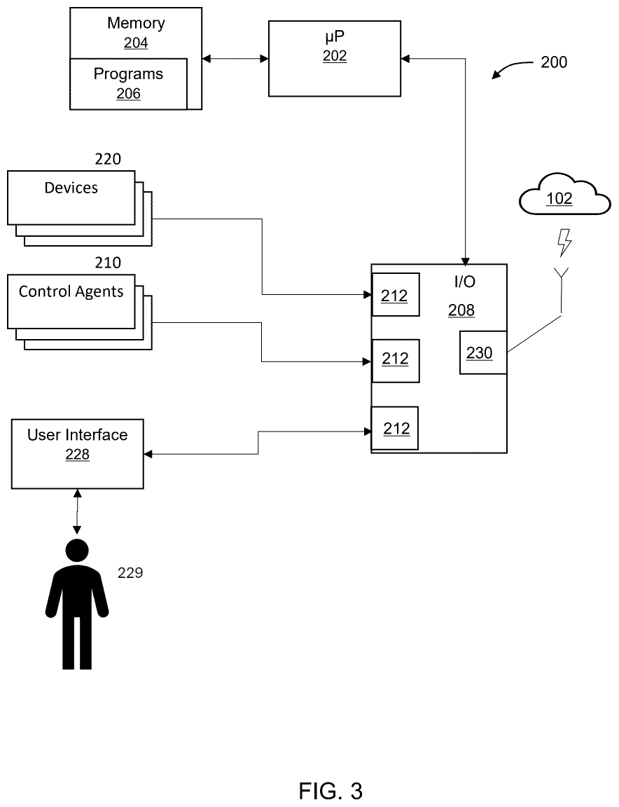

Referring now to FIG. 3, shown therein is a schematic diagram of a processor circuit 200 for implementing a control agent 110 (e.g. 110A-1), according to an embodiment. The processor circuit 200 is accordingly variously referred to as a control agent 200 herein. The control agent 200 may be implemented using an embedded processor circuit such as a Linux-operated computer. The control agent 200 includes a microprocessor 202, a memory 204, and an input output (I/O) module 208, all of which are in communication with the microprocessor 202. The I/O 208 includes one or more wireless interfaces 230 (such as an IEEE 802.11 interface) for wirelessly receiving and transmitting data communication signals between the control agent 200 and other agents or the cloud server 102 through a wireless network. The I/O 208 further includes a plurality of wired network interfaces 212 (such as an Ethernet, USB, CAN interface) for connecting to IoT devices 220 and a plurality of control agents 210. The I/O 208 may further be in communications with a user interface 228 for facilitating interactions between the control agent 200 and a user 229.

The user interface 228 is configured to receive information, such as logged data, from the control agent 200, to program the control agent 200, for example by storing programs 206 on the memory 204, or for diagnosing or configuring the control agent 200. The user 229, in controlling or providing input to the user interface 228, may accordingly program the control agent 200. Alternatively, the user 229 may interact with the control agent 200 through a user interface of the cloud server 102 or a user interface of another control agent.

The programs 206 are embodied or stored in one or more non-transitory computer-readable storage media. The programs 206 include various instructions, such as rule-based algorithms or machine-learning-based algorithms, to instruct the control agent 200 to manage the devices 220 (e.g. monitoring the devices 220 and sending commands to the devices 220 in a closed-loop manner) and how to function within the network with the plurality of control agents 210 and the cloud server 102.

The programs 206 may include instructions for the control agent 200 to monitor one or more of the devices 220 (e.g., read data and track metrics of the devices 220) with a set sampling rate. The programs 206 may further include functions which when triggered are configured to cause the control agent 210 to send a command to one or more of the devices 220. For example, the programs 206 may include instructions for reading and tracking power consumption of the devices 220 and, when the power consumption of a device within the devices 220 increases above a maximum threshold, triggering the control agent 210 to commission a command to the device 220 to cause the device 220 to reduce the power consumption below the threshold (e.g., shutting down the device 220, underclocking the device 220, or by reducing workload to the device 220, among other examples). The agents 210 may be instructed to keep track of all or a portion of historical data read and recorded from the devices 220. To prevent loss of data but further to prevent collecting unnecessary data, the agents 210 may be programmed to store some or all of the collected data from the devices 220 and commands and events communicated by or to the agents 210. The stored data may be shared with other agents 210 or shared with the cloud server 102 for safe keeping. Some or all of such data may be compressed or processed according to a given protocol to reduce the data storage size. In some examples, the cloud server 102 may request the agents 210 to send a specific batch of data related to a specific time frame and/or related to a specific batch of devices 220 and/or specific set of metrics or device data.

In an embodiment, a user 229 programs a first control agent 210 by a set of rules which, when triggered, are configured to initiate commissioning commands to the devices 220. Such programs 206 may be shared with other control agents 210 by directly being communicated with the other control agents 210 or by being broadcasted by the first control agent 210 to the network of other control agents 210.

In an embodiment, the control agents 210 are virtual control agents 210 implemented by a virtual machine (VM) or a loadable software container (e.g., using Docker™) that reside on a physical controller or computer (e.g., stored on a computer and loadable by a microprocessor, such as the microprocessor 202). For example, a single physical controller (or physical computer) may run two or more virtual control agents 210, with each virtual control agent 210 being assigned a separate batch of devices 220 and being configured to monitor and manage the assigned batch of devices 220.

An agent (e.g., the agent 110A-1) may be assigned to a batch of devices based on a variety of criteria, such as random assignment, physical location of devices (e.g., agents 110 being assigned to a group of devices 120 physically closest to the agent 110); IP or MAC address or range of devices 120 or agents 110, and electrical infrastructure phase (e.g., an agent 110 being assigned to only devices 120 that are powered by phase 1 of an electrical power source, as phase management and balancing phases may impact energy consumption of the devices 120).

In an embodiment, the cloud server 102, a superior agent (which may be referred to as an agent 110s hereafter), or an arbitrary agent 110 may define rules and criteria for assigning devices 120 to agents 110. The superior agent 110s is a control agent 110 distinguished by a special characterization, such as possessing unique identifiers (e.g., the smallest or largest ID, IP, or MAC address), being the oldest agent in the network (i.e., the first to join the network), or having superior computational resources (e.g., enhanced CPU or memory capacity). The devices 120 may be assigned to agents 110 according to IP and/or physical address of agents 110, based on the capacity and capability of each agent 110 such as memory capacity, CPU capacity, communication capacity, and number of ports on the agent 110. The assignment may be initiated by the cloud server 102, the superior agent 110s, or by the arbitrary agent 110 based on defined rules. In one embodiment, the criteria to assign devices 120 to agents 110 are dynamic and may be changed according to a rule (e.g., during peak grid power consumption, assign devices 120 with similar electrical phase to one assigned agent 110) that could be defined manually or automatically by the cloud server 102 or an agent 110. In some embodiments, one superior agent 110s broadcasts device assignment rules and criteria to one or more other agents 110 or alternatively broadcasts the ID of devices 120 assigned to each agent 110 such that all agents 110 are informed about their own assigned batch of devices 120 as well as the batch of devices 120 assigned to other agents 110 in the network.

According to one embodiment, the agents 210 are requested to scan for devices 220 available in the network. The request may be administered manually such that a user (e.g., the user 229 or a user of the cloud server 102) sends commands to one or more agents 210 to find new or missing devices 220 in the network. Once new devices 220 are found on the network, an agent 210 is assigned to the devices 220 and rules or commands will be set related to the newly found devices 220. The request may be programed into the agents 210 where one or more agents 210 periodically scan for new devices 220 in a set IP range, and once new devices 220 are found, agents 210 are assigned to the found devices 220 and rule or commands are set on the newly found devices 220. The request may be triggered based on an event (e.g. if a device 220 is missing from a list of devices 220). The scanning to find the missing device 220 may happen periodically, may happen once, or may happen continuously with a set frequency until the missing device 220 is found.

In an embodiment, one or more roles are defined for assumption by the agents 210. For example, an agent 210 may be a master in network commands (i.e., administering and commissioning network scanning, finding new devices 220 in the network, updating a list of devices 220 in the network), while another agent 210 may be a master in distributing device commands (i.e., administering and commissioning commands to devices 220 such as power cut commands, device shutdown commands, etc.).

The agents 210 may also communicate with one another to share or broadcast assigned devices 220, status of devices 220, handle command delegation, and provide redundancy. This peer-to-peer communication enables the agents 210 to coordinate device management in case a change occurs in the network, such as if an agent 210 fails, an agent 210 is added, a new batch of devices 220 enters the network, or an existing batch of devices 220 are removed from the network. In an embodiment, each agent 210 includes a log file that may be shared with other agents 210 or the cloud server 102. The log file may be stored on a memory of the agent 210 or otherwise accessible to a processor of the agent 210. If stored on the memory of the agent 210, the log file may be shared with the system 100 by being broadcasted to the network or being directly sent to each agent 210 or to the cloud server 102. Thus, the log file may be stored or otherwise located on a memory of the cloud server 102, each agent 110, a batch of agents 110, or one agent 110. The log file may include a physical or network address or ID of each and all agents 210, the health status of each and all agents 210, and a list of all devices 220 in the network, a list of assigned devices 220 to each and all agents 210 and their status and specs (e.g. operational status, online or offline status, nominal power consumption). The log file may be a single live (synchronized) document that is shared and used by all agents 210 and/or the cloud server 102. All the agents 210 may have read and write access to the log file and may be configured to update the file as needed. In some examples, two or more versions of the log file, which are not identical, may be stored or broadcasted among the network in an instance. In this case, some time may be needed for all devices 220 to synchronize their log file to a single true version. The cloud server 102 or one of the agents 210 may be responsible to ensure synchronization between different versions of the log file.

The agents 210 are configured to share responsibility for device management by dynamically reassigning (or rebalancing) assigned devices 220 when there is a change in the network's configuration (e.g., addition or removal of devices 220 or control agents 210) or operating conditions affecting the balance, availability, or efficiency of device 220 management by the control agents 210 (e.g., workload on an agent 210 increases to reach the effective capacity of the agent 210). For example, referring to FIG. 2B, if an agent (e.g., the agent 110A-1 as shown in FIG. 2B) fails, is not responsive to other agents 110, or goes offline, the devices 120 assigned to the failed agent (i.e., the device batch 122A-1) are reassigned or distributed to one or more other agents (e.g., agent 110A-2). All devices 120 in the network may be considered for a new reassignment of devices 120 to agents 110. In the embodiment shown in FIG. 2B, the devices 120A-1 to 120A-3 are regrouped in the device batch 122A-1 and assigned to the agent 110A-2 while devices 120A-4 to 120A-m1 are regrouped in device batch 122A-2 and assigned to agent 110A-n. As mentioned hereinabove, the assignment may be based on factors such as IP address, physical proximity, and the overall load or capacity of the agents 110. This cooperative structure ensures that device control remains efficient and distributed across the system 100. The determination that the agent 110A-1 has failed and is offline may be made by the cloud server 102 or another agent, such as the agent 110A-2.

Additionally, when a new agent 110 is added to the network, the devices 120 may be rebalanced accordingly to distribute device management responsibility among the new network of agents 110. The log file may be updated accordingly to reflect removal or addition of agents 110 to the network and the new reassignment of the devices 120 to existing agents 110.

In an embodiment, the agents 110 are capable of independent operations, enabling the agents 110 to stop or control the devices 120 without relying on the cloud server 102. In other words, the agents 110 do not depend solely on the cloud server 102 and are configured to manage the devices 120 independently, ensuring resilience of the system 100 to network outages or failures of the central cloud server 102. Additionally, the agents 110 may be configured to share or broadcast state data (read/write/stop) with one another, facilitating decentralized decision-making among the agents 110. In one example, a command is automatically generated or manually generated by the user 229 on one of the agents 110 to command all agents to send a further command (e.g. start, pause, shutdown, underclock, overclock commands) to all or a specified portion of their assigned devices 120. The command may be shared directly or broadcasted to other agents 110 by using the log file updated by the agent 110. All other agents 110 follow the commissioned command to execute them on all or the specified portion of their assigned devices 120.

Referring to FIG. 2C, a batch 122A-3 of devices 120A-m and 120A-m1 is assigned to multiple agents 110 at the same time to provide redundancy and fault tolerance for device management. For instance, two agents 110A-n and 110A-n1 assigned to the same batch of devices 120 monitor and issue commands concurrently, providing operational redundancy in case one agent 110 fails. This redundancy adds an extra layer of reliability in managing the devices 120 by ensuring continuous operation and management of the devices 120 without disruption.

Once an agent 110 is added to the system 100 (or network), the existing agents 110 may communicate the new architecture of the network (e.g., IP, MAC addresses of existing agents 110 and list of devices 120 assigned to each agent 110) to the new agent 110. The system 100 (through instructions from the cloud server 102 or from an agent 110) is configured to automatically rebalance device assignments across all available agents 110. Similarly, if an agent 110 goes offline, the remaining agents 110 detect the failure and redistribute the affected devices accordingly.

In general, rebalancing of the devices 120 occurs when a new agent 110 is introduced to the system 100, an agent 110 goes offline, devices 120 are added to or removed from the system 100, or workload with respect to the devices 120 becomes imbalanced among the agents 110. Examples of imbalanced device workload includes imbalanced communication or response speed between devices 120 and an agent 110, imbalanced overall scan time of devices 120 by the agent 110, and imbalanced data volume or size communicated between the agent 110 and the assigned devices 120. In an embodiment, as an alternative to the cloud server 102, or the superior control agent 110s, an agent 110 detecting load imbalance or agent failure broadcasts a rebalancing request to its peers.

The commands to the devices 120, that are administered by the cloud server 102 or agents 110, may be based on various factors such as energy/power consumption levels by each device 120 or the overall facility 104 and operational costs of each device 120 or the overall facility 104. The commands may also be based on, at least in part, obligations related to the facility 104 or the devices 120, such as contractual, regulatory, or certification obligations of the facility 104 or the devices 120. Such obligations may include environmental, social, and governance (ESG) obligations, energy contracts, agreements, and obligations (such as power purchase agreements (PPAs), energy hedges, and participation in ancillary services and demand response programs), and reducing environmental impacts (such as reducing GHG emission footprints).

An energy agreement may include agreements with one or more authorities managing the energy grid 130, a behind-the-meter (BTM) power supply, or any other external service providers administering energy sourcing to the facility 104. The energy agreement may include power blocks purchased from the energy grid 130, power purchase agreement (PPA) between the facility 104 and BTM supply, Virtual PPA (VPPA), energy hedge agreement with a non-energy grid counterparty to manage the financial risk in energy cost fluctuations, or incentive program agreements such as ancillary services and demand response program agreements, introduced by energy grid authorities, for example, to support the frequency regulation, voltage regulation, and balancing supply and demand in the energy grid 130 network.

Moreover, the energy agreement may include programs that allow the facility 104 to flow excess energy generated from a co-located BTM supply or backup power storage to the energy grid 130 for a benefit such as monetary incentives.

Through any of these energy agreements, the facility 104 may be incentivized or may have the option to stop consuming energy, to sell back energy to the energy grid 130, to sell excess energy to the energy grid 130, to sell the option to purchase or use energy to the energy grid 130 or another interested entity, to cut energy consumption during certain time periods, to perform load shaping (i.e., to cause or achieve a particular load level over time, for example, maintaining a minimum energy consumption profile during certain time intervals, or having a certain level of device uptime), or to commit to consume certain amounts of energy in certain times. A person of skill in the art will understand that various types of energy agreements may exist between the energy grid 130 and the facility 104.

In an embodiment, the energy agreement is an energy option agreement, i.e., an agreement between the energy grid 130 and the facility 104, and associated with the delivery of energy to the facility 104. As part of the power option agreement, the facility (or the facility operator, contracting agent for the facility, and semi-automated and/or automated control system associated with the facility—such as facility administration controllers) provides the energy grid 130 with the right, but not the obligation, to reduce the amount of energy delivered to the facility 104 up to an agreed amount of energy during an agreed upon time interval. In order to provide the energy grid 130 with this option, the facility 104 needs to be using at least the amount of energy subjected to the option (e.g., a minimum energy threshold). For instance, the facility 104 may agree to use at least 1 MW of energy from the energy grid at all times during a specified 24-hour time interval to provide the energy grid 130 with the option of being able to reduce the amount of energy delivered to the load by any amount up to 1 MW at any point during the specified 24-hour time interval. The facility 104 may grant the energy grid 130 this option in exchange for a monetary consideration such as receiving energy at a reduced price and/or monetary payments if the option is exercised by the energy grid 130.

In an embodiment, the power option agreement provides a sequence of minimum energy limits over different periods of time. The power option agreement may provide maximum power consumption targets that the facility 104 is committed to stay below.

According to an embodiment, the commands to the devices 120, which are administered by the cloud server 102 or agents 110, may be based on a target power consumption target for the facility 104. The target power consumption may be derived or prescribed from the above-mentioned energy agreements or obligations (which may be derived from mandatory directives or optional directives such as grid incentive programs) or may be derived from other factors such as overall cost (energy cost, operational costs, and overall compute cost) and environmental impacts of the facility 104. Accordingly, the target power consumption may be provided as an input to the cloud server 102 or an agent 110 or may be calculated by the cloud server 102 or an agent 110 according to a rule. The power consumption target may include minimum and/or maximum power thresholds to which the energy consumption profile of the facility 104 is bound. The minimum and maximum power thresholds may vary over time in a stepwise manner or in a dynamic manner (i.e., with continuous change over time). In some examples, the target power consumption may include a range (including both a minimum and a maximum) rather than a single minimum threshold or a single maximum threshold. In some examples, over some periods of time, there may be no mandatory power consumption target, and the facility 104 may have a degree of freedom in consuming unbounded energy and depending on its demand. In some embodiments, the minimum power threshold may be zero.

In some embodiments, the cloud server 102 or one or more agents 110 jointly determine a target power consumption for the facility 104 and/or one or more additional control targets such as a target temperature profile for one or more zones, equipment groups, or cooling systems within the facility 104, and an associated energy sourcing mix target. The target power consumption may specify the total power or energy level for the facility 104 over a plurality of time intervals, while the energy sourcing mix target may specify, for the same or overlapping time intervals, how much of the total power or energy is to be obtained from each power source (such as the energy grid 130, BTM power generation units, and energy storage units). In some cases, a target temperature profile may specify, for each of a plurality of time intervals, one or more target temperatures or temperature ranges for devices, racks, rooms, or other zones, and the system 100 may operate cooling-related devices to track the target temperature profile. Together, the target power consumption, the target temperature profile (when present), and the energy sourcing mix target define a multi-dimensional operational target for the facility 104 that constrains both the total energy usage and temperature behavior and the mix of energy sources. In some cases, these targets are also coordinated with workload-level requirements (such as critical versus curtailable tasks) and program obligations (such as demand response or ancillary service programs) so that changes in energy sourcing are aligned with workload scheduling and operational needs of the facility.

According to an embodiment, the cloud server 102 executes an optimization engine that computes the target power consumption and energy sourcing mix target and, in some embodiments, one or more target temperature profiles or cooling targets based on multiple objectives and constraints. The objectives may include, for example, reducing or minimizing energy cost, reducing or minimizing environmental impact (such as aggregate greenhouse gas emissions associated with the consumed energy), satisfying energy agreements and load-shaping directives, preserving the health or lifetime of energy storage units, and maintaining temperatures within desired ranges for particular equipment, spaces, or zones. Constraints may include, without limitation, minimum or maximum power consumption thresholds, minimum or maximum contribution thresholds for particular power sources, maximum charge or discharge rates of energy storage units, mandatory minimum uptime for specific devices or subsystems, and maximum allowable temperatures or temperature gradients for selected equipment or zones. The optimization engine may be implemented using any suitable optimization technique, such as rule-based decision logic, linear or non-linear programming, or learning-based control policies. In some embodiments, the optimization engine is configured to optimize a target parameter that may correspond to one or more of: an energy consumption metric, a financial metric such as facility profit or energy cost, a sustainability metric such as greenhouse gas emissions or water use, and may also consider comfort- or reliability-related metrics associated with temperature or cooling performance, while enforcing the above constraints.

In a particular example, the optimization engine determines, for each time interval in a day, a target power consumption level for the facility 104 and a set of target percentages specifying a desired contribution from the energy grid 130 and from one or more energy storage units. During hours when the energy grid 130 offers lower energy prices or lower carbon intensity, the optimization engine may bias the energy sourcing mix target toward a higher utilization of grid power, whereas during hours with higher prices or higher carbon intensity, the optimization engine may bias the energy sourcing mix target toward a higher utilization of energy storage or BTM renewable generation. The optimization engine may also enforce that a minimum share of power is supplied from the energy grid 130 or from a particular BTM source in order to satisfy minimum-consumption or offtake obligations under an energy agreement. In some embodiments, the optimization engine additionally determines, for each time interval, one or more target temperatures or temperature ranges for selected zones or cooling subsystems, thereby defining a target temperature profile that the collaborative agents 110 will attempt to track while following the target power consumption and energy sourcing mix targets. In another example, the optimization engine may determine that it is economically advantageous to store energy in the energy storage units during low-price periods and discharge or export energy during high-price periods, thereby arbitraging energy prices while still complying with energy agreements, sourcing mix constraints, and operational limits of the storage systems.

The commands commissioned by the cloud server 102 or the agents 110 may direct the energy consumption of the device and thus the overall facility 104 to follow target power consumption levels or follow various load shaping profiles. In one example, the commissioned commands may instruct the devices 120 to operate in such a way to increase the power consumption of the facility 104 above a minimum threshold which is the target power consumption or decrease the power consumption below a maximum threshold. According to another example, the commissioned commands may instruct the devices 120 to operate in such a way to increase or decrease the power consumption of the facility 104 to reach or follow the target power consumption levels over various periods of time.

In some embodiments, one or more of the devices 120 comprise energy storage units, and the agents 110 monitor and control the state of charge (SOC) of these energy storage units. The SOC may represent, for example, the percentage of usable capacity remaining in a battery energy storage system. The agents 110 may monitor SOC and other charge-related metrics, such as remaining runtime, charge or discharge power, and estimated degradation, as part of the status, data, and metrics described above. The system 100 may maintain target SOC ranges for each energy storage unit, such as a minimum SOC threshold to preserve a reserve for grid-frequency response programs or backup power, and a maximum SOC threshold to limit degradation of the storage unit. In some implementations, the energy storage units may include battery systems, flywheels, uninterruptible power supplies, or hydrogen fuel tanks and associated fuel cells, and the SOC may represent stored electrical energy or stored chemical energy (for example, an amount of hydrogen fuel available for later conversion to electricity). In some embodiments, SOC-related targets are determined in coordination with target power-consumption profiles, target temperature profiles, and energy sourcing mix targets so that storage operation supports both energy and cooling or temperature-management objectives without violating storage health constraints.

In an embodiment, the cloud server 102 determines a desired SOC trajectory for one or more energy storage units over a planning horizon. The SOC trajectory may specify, for each time interval, a target or allowable range of SOC values that is consistent with the target power consumption and energy sourcing mix target and, in some implementations, with any target temperature profiles determined for the facility 104. The cloud server 102 may further determine charge and discharge setpoints and maximum charge or discharge rates for each time interval, subject to constraints such as inverter capacity, thermal limits, cycling limitations, and grid-service requirements. These SOC-related directives may be communicated to the agents 110, which in turn generate closed-loop device-level commands (for example, to inverters, switches, or other power-routing devices) to achieve the desired SOC trajectory while ensuring that the overall facility 104 follows the target power consumption and energy sourcing mix targets and maintains temperatures within the target temperature profiles, when such profiles are present. If the agents 110 detect that SOC or power flows deviate from the planned trajectory, the agents 110 may take corrective actions such as temporarily increasing or decreasing charge or discharge power, altering which loads are supplied by storage versus the energy grid 130, or adjusting other device settings to restore compliance with SOC, power, and sourcing objectives. For example, when SOC falls below a lower threshold, the agents 110 may increase charging from the energy grid 130 or from BTM generation; when SOC exceeds an upper threshold or when energy prices are high, the agents 110 may command discharge of the energy storage units to supply facility loads or to export energy to the grid for a profit, consistent with the control strategy and target parameters described herein, which may include both energy-consumption and temperature or cooling targets.

In accordance with another embodiment, the commands commissioned by the cloud server 102 or the agents 110 may be based on a grid frequency response program which may be derived or prescribed from the above-mentioned energy agreements or obligations (which may be derived from mandatory directives or optional directives such as grid incentive programs such as fast frequency response (FFR), or primary frequency response (PFR) programs in the Electric Reliability Council of Texas (ERCOT)) or may be derived from other factors such as overall instability and reliability in the sourced power within the facility 104. One of the IoT devices 120 may be a frequency meter (e.g., a synchro-phasors measurement device) configured to measure the frequency of the power supplied by the power grid 130. The frequency measurements may be monitored by an agent 110, which may then trigger one or more commands to the devices 120 according to a rule to comply with frequency response programs of the grid 130. For example, if the frequency drops below a prescribed threshold (indicating a shortage of power generation in the grid 130), an agent 110 connected to the frequency meter may trigger a command to modify the operation of the devices 120 (e.g., shutting down a portion of the devices 120) to reduce the overall power consumption of the facility 104 quickly. The power consumption reduction may be active for a predetermined time (e.g., 15 minutes) prescribed by the frequency response program, or until the frequency reaches a safe threshold for a reliable period of time, or until the frequency responsiveness is recalled by a grid operator, for example.

Key advantages of the device management system 100:
decentralized control and management with the cloud server 102 providing a supervisory or backup role, such that while the cloud server 102 provides oversight and high-level coordination, the control agents 110 may be configured to act semi-autonomously or autonomously;
efficient and scalable device management by sharing and rebalancing device management among multiple collaborative agents 110;
redundant device management for increased reliability: by assigning multiple control agents 110 to the same batch 122 of devices, the system 100 provides high reliability;
adaptive and flexible assignment and reassignment of the devices 120, which allows for dynamic assignment and rebalancing of the devices 120 across the control agents 110, based on various factors and rules that may further be flexible (this helps optimize resource usage, enhance energy efficiency, and provide robust fault tolerance); and
closed-loop management of the devices 120 by the agents 110, which continuously monitor the success of command execution, reducing the need for manual intervention and minimizing downtime.

### EXAMPLES

### Example 1—Device Monitoring in a Datacenters

Monitoring power consumption is highly desirable in a datacenter for optimizing energy efficiency and preventing overloading of electrical phases. Agents 110 may be configured to track the real-time energy consumption of individual devices 120 such as ASIC miners, Power Distribution Units (PDUs), and computing servers. If power usage spikes unexpectedly, the agent 110 may take corrective action, for example redistributing the power load. In doing so, agents 110 may track key metrics in individual devices 120, across a batch of devices 122, or across all devices 120. Such metrics may include Watts consumed, voltage, current, energy efficiency (e.g., PUE—Power Usage Effectiveness).

In one particular example, PDUs, which are responsible for distributing electrical power to various equipment such as computing servers and networking devices, are managed by agents 110 to track the on/off state of each PDU to ensure the PDUs are delivering power as expected. The agents 110 read the PDU's power status (e.g., powered on, off, or in a fault state). If a PDU fails (e.g., due to overheating or a power surge), the agent 110 is configured to alert the cloud server 102 or trigger immediate corrective action such as starting a root cause analysis, fault detection, and/or maintenance procedures or redistributing power load to another PDU. The agents 110 track various key metrics in a PDU such as number of failures, on/off status over time, uptime, and energy consumption levels. Moreover, the agents 110 track power loads across different electrical phases to prevent overloading or underloading of PDU circuits, which may cause inefficiency or potential outages. If a phase is imbalanced, agents 110 redistribute power loads or trigger shutdowns in low-priority devices 120 or device batches 122 to ensure operational stability. The agents 110 further monitor voltage, frequency, and current levels to avoid equipment and device damage due to electrical fluctuations.

### Example 2—Scanning Devices in a Datacenter Facility

In a large-scale datacenter, for the management of IoT devices (e.g., servers, ASICs, PDUs, cooling systems, sensors) it is highly desirable to provide continuous monitoring to ensure that all devices are online and functioning properly. To streamline this process using the proposed device management system 0100, a request to scan the network of connected devices 120 may be initiated manually by a user or operator of the datacenter (e.g., the user 229), programmatically, or triggered by an event (e.g., a missing device 120 from the log file). For example, a datacenter operator identifies a need to check for missing or new devices 120 in a specific part of the datacenter facility (e.g., Site A 104). The operator issues a manual command to the agent 110 which has assumed the network master role (called master network agent 110x hereafter), which is responsible for managing the network scan and device discovery procedure. The command instructs the master network agent 110x to perform a full scan of the network, listing all available devices 120 in a specific IP range (e.g., 192.168.0.1 to 192.168.0.255). Besides the IP or address range, the command may further include the type of searched devices 120 (e.g., ASICs, PDUs, cooling devices, temperature sensors, humidity sensors, and smoke detectors), and a scan frequency (e.g., immediate, with periodic follow-ups every 6 hours).

The master network agent 110x may perform the scanning duty itself or may delegate the scanning responsibility to an agent 110y designated specifically for network scanning duties (called scanning agent 110y hereafter). The scanning agent 110y may be selected based on its proximity to the devices 120 or its role in the network. The master network agent 110x communicates the commissioned commands by the operator to the scanning agent 110y, detailing the specific IP range, device types to be scanned, and other command parameters such as frequency of scans. The scanning agent 110y may acknowledge the request and prepare to scan the designated network segment. The scanning agent 110y initiates a network scan, pinging each IP address within the specified range to discover active devices 120. The scanning agent 110y performs this task using communication protocols such as TCP/IP, querying devices 120 for their status, capabilities, and metrics. For each scanned device 120, the scanning agent 110y may log or record the device type, device ID, device status (e.g., online/offline), and device metrics (e.g., power consumption, temperature, and uptime). The scanning agent 110y may also mark new devices 120 added to the network (e.g., new devices 120 that were not present in a previous scan) and/or missing devices 120 (e.g., if a device 120 from a known list is not responding). The missing devices 120 may be flagged for further investigation.

Once the scan is completed, the scanning agent 110y shares its log file with the master network agent 110x. The master network agent 110x may update a central log file of devices in the network and rebalance device assignment to control agents 110 based on predefined criteria (e.g., proximity, CPU/memory capacity, or network load balancing). For example, a new ASIC 120 discovered at IP address 192.168.0.20 may be assigned to an ASIC control agent 110 with sufficient processing capacity to manage additional devices. Similarly, if a PDU is found missing, an alert is sent to the corresponding PDU control agent 110, which may trigger corrective actions (e.g., physical inspection or power cycle commands).

For newly found and assigned devices 120, an agent 110 responsible for setting device command rules (called master device commands agent hereafter), may issue commands to agents 110 to configure the devices 120. The configuration commands may include assigning IP addresses, defining rules for monitoring device metrics (e.g., power usage thresholds for PDUs), and setting power management rules, such as shutting down devices during off-peak hours to save energy or issuing alerts if a sensor detects abnormal temperature levels. Doing so allows the newly discovered devices 120 to become fully integrated into the datacenter's IoT system 100, establishes continuous monitoring, and ensures that all devices 120 are accounted for, properly assigned, and governed by rules.

### Example 3—Multi-Source Energy Orchestration with Energy Storage

In another example deployment, the facility 104 is a datacenter or an industrial facility that receives power from the energy grid 130, from a behind-the-meter solar photovoltaic (PV) array, and from a battery energy storage system (BESS). The BESS is connected to the facility 104 and to the energy grid 130 through one or more inverters and switching devices, which are included among the devices 120. The agents 110 monitor power consumption across ASIC miners, servers, PDUs, cooling systems (including fans, pumps, and refrigeration equipment), and other subsystems, as well as power flows to and from the solar PV array and the BESS. A power routing subsystem, which may include one or more power transfer switches, power distribution units, inverters, mechanical or solid-state breakers, and other power converters, is configured to receive energy from the different sources and to deliver mixed energy to the energy-consuming devices.

In this example, the facility operator has entered into an energy agreement that defines a minimum power consumption threshold from the energy grid 130 during certain peak hours and has also committed to participate in a demand response or fast frequency response program. The cloud server 102 determines a daily target power consumption profile that respects the minimum energy consumption threshold during the contractual period and simultaneously determines an energy sourcing mix target that, during a first set of time intervals, requires at least 80% of instantaneous power to be supplied from the energy grid 130 and the remaining 20% from the solar PV array and BESS combined. During another set of time intervals, when energy prices or carbon intensity are high, the energy sourcing mix target may be adjusted so that no more than 50% of instantaneous power is supplied from the energy grid 130 and at least 50% is supplied from the solar PV array and the BESS. The facility 104 may execute both critical workloads (such as time-sensitive compute tasks) and curtailable workloads (such as energy carrier production or cryptocurrency mining), and scheduling of these workloads is coordinated with the energy sourcing mix target and the energy agreements and, in some embodiments, with one or more target temperature profiles for the datacenter or industrial facility.

The cloud server 102 also determines a SOC trajectory for the BESS over the same time horizon. For example, the BESS may be required to maintain an SOC between 40% and 90% of its usable capacity at all times, with a tighter target band of 60% to 80% during time intervals when the facility 104 is obligated to be ready to provide frequency response to the energy grid 130. The cloud server 102 may prescribe the BESS charge during low-price or low-carbon periods, for example to raise SOC from 50% to 80%, and then discharge during high-price or high-carbon periods, for example to lower SOC back to 60%, while ensuring that the minimum SOC threshold is not violated so that the BESS is still able to provide required grid-services responsiveness. In some embodiments, the SOC trajectory also ensures that sufficient headroom is maintained to provide ancillary services such as frequency regulation, demand response, or other grid-support services to the energy grid 130.

Agents 110 assigned to the PDUs, inverters, and other power-interface devices execute the strategy determined by the cloud server 102. During each time interval, the agents 110 monitor real-time power consumption of device batches, real-time contributions from the energy grid 130, the solar PV array, and the BESS, as well as the current SOC of the BESS. Agents 110 also monitor temperature metrics for selected devices, racks, or zones served by the cooling systems. Based on this information, the agents 110 generate commands that adjust power flows, for example by instructing a given inverter to increase or decrease discharge power from the BESS, by switching one or more loads from being supplied by the energy grid 130 to being supplied by the BESS, or by throttling non-critical loads. The agents 110 may also instruct the BESS to charge from the solar PV array or from the energy grid 130 when required to maintain or restore the SOC trajectory. In addition to adjusting power flows, the agents 110 may adjust operation of cooling-related devices, for example by modifying fan speeds, pump speeds, or compressor duty cycles, in order to maintain measured temperatures within target ranges defined by one or more target temperature profiles for the facility 104, while still tracking the target power consumption and energy sourcing mix targets. In addition to adjusting power flows, the agents 110 may also schedule or throttle curtailable workloads so that charging of the BESS during low-price periods and discharging during high-price periods is coordinated with execution of those workloads.

If the agents 110 detect that the measured sourcing mix (for example, the percentage of power currently supplied from the energy grid 130 versus the BESS) deviates from the energy sourcing mix target beyond a tolerance, or that the SOC deviates from the target SOC trajectory beyond an allowable range, or that measured temperatures deviate from the corresponding target temperature profiles beyond a tolerance, the agents 110 may take corrective actions. These corrective actions may include increasing or decreasing charge or discharge power, temporarily reassigning certain loads between power sources, curtailing or boosting power consumption of particular device batches, or updating local control parameters, and may further include modifying operation of cooling-related devices such as fans, pumps, or refrigeration systems to bring measured temperatures back within the target temperature ranges. The corrective actions are taken in a closed-loop manner, with the agents 110 continuously monitoring updated power flows, SOC metrics, and temperature metrics to confirm that the sourcing mix and SOC return to their respective target ranges and that temperatures track the associated target temperature profiles.

Through this multi-source orchestration, the system 100 allows the facility 104 to simultaneously comply with energy agreements, reduce energy costs, reduce environmental impacts associated with energy consumption, and maintain readiness to provide grid services, while also managing the SOC and health of the BESS and maintaining temperatures within the desired target temperature profiles for the facility 104. This example illustrates how the combination of the target power consumption, the energy sourcing mix target, and the SOC trajectory and, in some embodiments, one or more target temperature profiles may be implemented in practice using the collaborative agents 110 and the cloud server 102.

1. A system for monitoring and managing a plurality of devices including at least one energy-consuming device in a facility, the system comprising:
a network comprising the plurality of devices wherein the plurality of devices include a cooling system comprising one or more cooling devices;
a plurality of control agents connected to the plurality of devices, each control agent from the plurality of control agents being assigned to a batch of devices from the plurality of devices to share management of the plurality of devices among the plurality of control agents;
wherein each respective control agent from the plurality of control agents is configured to:
monitor at least one device in the assigned batch of devices by obtaining data representing a status of the device and at least one metric associated with operation of the device, the at least one metric including a temperature metric associated with one or more of the cooling devices or a zone of the facility served by the cooling system;
generate a command based at least in part on the data, the command being configured to satisfy a temperature target for the cooling system;
send the command to the at least one device in a closed-loop manner;
wherein the respective control agent further monitors execution of the command by the at least one device;
wherein the command is re-sent where the command is not executed by the at least one device or where there is an unexpected change in the status of the at least one device after successful execution of the command, wherein where the command is re-sent and after an elapsed time, the respective control agent proactively takes corrective action to verify that the temperature target for the cooling system is satisfied.

2. The system of claim 1, wherein the one or more cooling devices comprises at least one of a fan, pump, refrigeration unit, air-conditioning unit, and chiller.

3. The system of claim 1, wherein the command comprises at least one of: changing a fan speed, changing a pump speed, enabling or disabling a refrigeration cycle, and switching on or off the one or more cooling devices.

4. The system of claim 1, wherein the at least one metric further includes at least one additional metric selected from power-consumption metrics, environmental-impact-related metrics, and device-health metrics, and wherein the respective control agent is configured to generate the command based at least in part on the one additional metric.

5. The system of claim 1, wherein the command is further generated based on one or more control targets for operation of the facility, wherein the one or more control targets comprise at least a first control target based on one or more of an energy-consumption targets, energy-cost objective, an energy-sourcing mix target, and environmental impact targets for the facility and a second control target based on ensuring the temperature target for the cooling system, and wherein the respective control agent is configured to generate the command based at least in part on both the first control target and the second control target.

6. The system of claim 5, wherein the one or more control targets are obtained based on one or more energy agreements or program obligations applicable to the facility.

7. The system of claim 6, wherein a target power-consumption profile for the facility over a plurality of time intervals is obtained based at least in part on the one or more energy agreements.

8. The system of claim 5, wherein the plurality of devices further include one or more power-routing devices configured to route electrical energy from at least two power sources selected from an energy grid, a behind-the-meter generation resource, and an energy storage unit, and wherein the one or more control targets further comprise an energy-sourcing mix target specifying proportions or ranges of power to be obtained from the at least two power sources, and wherein the command is configured to cause the one or more power-routing devices to implement the energy-sourcing mix target.

9. The system of claim 8, wherein the energy-sourcing mix target specifies a minimum or maximum percentage of power to be supplied from the energy grid, the behind-the-meter generation resource, or the one or more energy storage units over one or more time intervals.

10. The system of claim 5, wherein the plurality of devices includes one or more energy storage units, and wherein the one or more control targets further comprise at least one state-of-charge (SOC)-related target for the one or more energy storage units, and wherein at least one control agent is configured to generate the command based at least in part on a measured SOC of the one or more energy storage units so as to maintain the measured SOC within a corresponding SOC-related target.

11. A computer-implemented method for monitoring and managing a plurality of devices including at least one energy-consuming device in a facility, the method comprising:
providing a network comprising the plurality of devices, wherein the plurality of devices include a cooling system comprising one or more cooling devices;
assigning, by one or more processors, a plurality of control agents to respective batches of devices from the plurality of devices to share management of the plurality of devices among the plurality of control agents;
for each respective control agent from the plurality of control agents:
monitoring at least one device in the assigned batch of devices by obtaining data representing a status of the device and at least one metric associated with operation of the device, the at least one metric including a temperature metric associated with one or more of the cooling devices or a zone of the facility served by the cooling system;
generating, based at least in part on the data, a command configured to ensure a temperature target for the cooling system;
sending the command to the at least one device in a closed-loop manner;
monitoring execution of the command by the at least one device; and
when the command is not executed by the at least one device or when there is an unexpected change in the status of the at least one device after successful execution of the command, re-sending the command and, when the command is re-sent and an elapsed time passes, proactively taking corrective action to verify the temperature target is ensured.

12. The method of claim 11, wherein the one or more cooling devices comprise at least one of a fan, pump, refrigeration unit, air-conditioning unit, or chiller.

13. The method of claim 11, wherein generating the command comprises at least one of: changing a fan speed, changing a pump speed, enabling or disabling a refrigeration cycle, and switching on or off the one or more cooling devices.

14. The method of claim 11, wherein the at least one metric further includes at least one additional metric selected from power-consumption metrics, environmental-impact-related metrics, and device-health metrics, and wherein generating the command comprises generating the command based at least in part on the at least one additional metric.

15. The method of claim 11, further comprising determining one or more control targets for operation of the facility, wherein the one or more control targets comprise at least:
a first control target based on one or more of an energy-consumption target, an energy-cost objective, an energy-sourcing mix target, and an environmental impact target for the facility; and
a second control target based on ensuring the temperature target for the cooling system;
and wherein generating the command comprises generating the command based at least in part on both the first control target and the second control target.

16. The method of claim 15, further comprising obtaining one or more energy agreements or compliance agreements applicable to the facility, wherein determining the one or more control targets comprises determining the one or more control targets based at least in part on the one or more energy agreements, and wherein at least one of the control targets comprises a target power-consumption profile for the facility over a plurality of time intervals obtained based at least in part on the one or more energy agreements.

17. The method of claim 15, wherein the plurality of devices further include one or more power-routing devices configured to route electrical energy from at least two power sources selected from an energy grid, a behind-the-meter generation resource, and an energy storage unit, and wherein the one or more control targets further comprise an energy-sourcing mix target specifying proportions or ranges of power to be obtained from the at least two power sources, and wherein generating the command comprises generating the command to cause the one or more power-routing devices to implement the energy-sourcing mix target.

18. The method of claim 15, wherein the plurality of devices include one or more energy storage units, and wherein the one or more control targets further comprise at least one state-of-charge (SOC)-related target for the one or more energy storage units, and wherein generating the command comprises generating the command based at least in part on a measured SOC of the one or more energy storage units so as to maintain the measured SOC within a corresponding SOC-related target.
